(19) United States
(12) Patent Application Publication
(10) Pub. No.: US 2024/0373086 A1
(43) Pub. Date: Nov. 7, 2024

(54) INTERACTIVE BROADCAST OVERLAY MAKING USE OF ULTRA-DYNAMIC QR CODE EMBEDDING

(71) Applicant: CONTENT DIRECTIONS, INC. DBA VIDEOSTORM, Brooklyn, NY (US)

(72) Inventors: Timothy Donald Ross, West Hartford, CT (US); Christopher Schacht, New York, NY (US); David Sidman, Brooklyn, NY (US)

(73) Assignee: CONTENT DIRECTIONS, INC. DBA VIDEOSTORM, Brooklyn, NY (US)

(21) Appl. No.: 18/771,986

(22) Filed: Jul. 12, 2024

Related U.S. Application Data
(63) Continuation-in-part of application No. PCT/US2023/014079, filed on Feb. 28, 2023.
(60) Provisional application No. 63/315,077, filed on Feb. 28, 2022.
(60) Provisional application No. 63/359,754, filed on Jul. 8, 2022.

(51) Int. Cl. H04N 21/431; G06K 7/14; G06K 19/06; H04N 21/4725; H04N 21/478; H04N 21/81

(52) U.S. Cl. CPC H04N 21/4316; G06K 7/1417; G06K 19/06037; H04N 21/4725; H04N 21/47815; H04N 21/812

(57) ABSTRACT

Methods for creating a bidirectional user interface associated with an audiovisual broadcast are disclosed. Along with the audiovisual broadcast, instructions are provided to generate a first user interface overlaid over the audiovisual broadcast by a device displaying the audiovisual broadcast. Upon capturing an identifier in the UI with a second device, a second user interface on the second device is generated, and the first user interface is updated to display information in conjunction with the second user interface. Methods are also disclosed for an Ultra-Dynamic Quick Response (QR) code. After a QR code encodes data that represents one or more variable values associated with an interface, and in response to receiving an input event representing that a change in value has occurred of at least one variable value, the interface is updated to replace the first QR code with a second QR code encoding data representing the change.

### CROSS-REFERENCE TO RELATED APPLICATIONS

This application is a continuation-in-part of International Application No. PCT/US2023/014079, filed Feb. 28, 2023 and titled “Interactive Broadcast Overlay Making Use of Dynamic QR Code Embedding”. That application derives priority benefit from U.S. Provisional Patent Application No. 63/315,077, filed Feb. 28, 2022 and titled “Dynamic QR Code Embedding in a Media Interface”, and from U.S. Provisional Patent Application No. 63/359,754, filed Jul. 8, 2022, and titled “Interactive Broadcast Overlay System”, both of which are hereby incorporated by reference in their entirety.

### FIELD OF INVENTION

This application relates to methods and systems for bidirectional communication between a screen used to display a broadcast and a computer server associated with that broadcast, possibly facilitated by use of QR codes, and more specifically, to methods and systems for creating interactive user interfaces that are overlaid onto a broadcast, that are responsive to local user input or other events, and that may be augmented by embedding a QR code in the interface and updating the QR code in response to user input or other events.

### BACKGROUND

In traditional television broadcast systems, communication is exclusively unidirectional; multiple signals from one or more broadcast sources are transmitted over the airwaves or through a cable network, and a television's antenna or cable box isolates one signal for display and consumption by the viewers of that television. Although modern cable television has provided greater options for more personalized entertainment, such as the ability to purchase films or pay-per-view events, the fundamental principle of displaying a same stream to every viewer remains typical.

The introduction of the Advanced Television Systems Committee standard (“ATSC 3.0”) and similar Connected TV (“CTV”) standards for “smart” televisions has made available a system based on the Internet Protocol (IP) for broadcast transmissions. A multiplexed stream of packets can carry information for both an underlying audiovisual stream and for additional data related to an internet-connected application running on a television or other device. It is expected that CTV standards will continue to develop over time and incorporate additional functionality in future versions of the ATSC standard or in any future standard that may be developed alongside or in place of ATSC to work with smart televisions or other display devices.

This combined data stream offers unique opportunities to implement interactive services that receive, parse, and respond to additional data packets while displaying an audiovisual broadcast transmission, but such applications have not yet been widely introduced or adopted.

Further, as part of any display, there may be a need to communicate information from the display to another computing device. Textual strings generated as part of the display may be used for a myriad of purposes during execution of software outside of the display, including a hyperlink URL (Uniform Resource Locator) for navigation by a web browser; tokens or access codes for two-factor authentication; or information on a passport, boarding pass, or other document.

When a hyperlink or other information is presented within one app on a personal computer or smartphone, it is simple to copy and paste that other information to another app on the same device, due to the shared clipboard functionality of all apps on a device. In contrast, it is at best tedious and at worst impossible for a human user to copy lengthy or dense textual information presented in a non-digital medium or on one device to another device, due to the lack of shared clipboard.

Quick response (QR) codes have quickly become the dominant method of encoding hyperlinks or other information for cross-medium copying. QR codes allow an optical scanner, such as a smartphone camera, to take a picture that contains the QR code. Even if the image is taken under poor lighting conditions, or from an arbitrary orientation, rotation, or angle, software is able to process the image and decode the encoded contents without error. The decoded contents can then be copied to the smartphone's clipboard for use in another app, or followed as a hyperlink in the smartphone's browser.

However, a key limitation of most QR codes, especially those printed on a physical medium, is that they are completely static. Once a QR code is generated and included within some medium, a hyperlink encoded within the QR code will always point to the same destination, even if that destination becomes inaccessible, deprecated, outdated, or unusable for its originally intended purpose. This limitation can be partially overcome by a method sometimes called “dynamic QR codes.” Although the QR code itself does not change and always encodes the same fixed destination URL as a placeholder, that URL merely points to a server that performs server-side processing and redirects a request to a new ultimate destination URL when receiving a request for the placeholder URL.

Even with this “dynamic” solution, there are drawbacks. The placeholder or deprecated URL is the same for every recipient of the QR code, so there is no capacity to include a log of client-side events or identifying information when a user captures the photo and is redirected to the ultimate destination URL. The server-side redirection functionality must always be on and listening, or the user will not be redirected and the QR code will simply appear to be broken or obsolete. The server-side functionality must be updated every time a change in the ultimate destination URL is desired.

Each of these limitations could be avoided if the QR code itself, the pattern of white and black bits actually visible to a human viewer, were capable of changing, instead of relying on an external, server-side processor to reinterpret the significance of a fixed encoded value.

As a result of all of the above context, there is an advantage to developing new interactive applications that provide functionality never experienced before on a television to a person who is viewing a broadcast, as well to increasing the dynamism of QR codes into such applications to provide novel functionality, without relying on server-side redirection.

### SUMMARY OF THE INVENTION

To address the opportunity afforded by these technologies, a system and method for creating a bidirectional user interface associated with an audiovisual broadcast are disclosed. The method begins by transmitting, along with the audiovisual broadcast, instructions to generate a first user interface that is overlaid over the audiovisual broadcast by a device displaying the audiovisual broadcast, then receiving a first command from a viewer of the audiovisual broadcast, causing an update to one or more values associated with the first user interface. In response, the method continues with creating, within the generated user interface overlay, an identifier to be used to access a second user interface on a second device. A user captures the identifier with the second device. The method then proceeds with generating the second user interface on the second device; receiving a second command from the viewer as the viewer uses the second device; updating the one or more values again; and finally, updating the first user interface to display information related to the updated one or more values that were updated from within the second user interface.

Such a system may radically transform the functionality available to smart televisions, enabling shopping carts, auctions, multiplayer games, social networking, and many other use cases that require bidirectional communication and have historically been limited to personal computers or smart phones. Video streams can be augmented with user interfaces to achieve virtually any use case that would historically have required a separation between one window for displaying a video, and another window for displaying a user interface.

Whether as part of the above-described system or in separate applications, it can be desirable to dynamically update a QR code itself, i.e., to actually change its visible, scannable pattern regardless of where it has already been distributed or displayed, rather than merely redirect an original URL destination to a new or different URL destination. The QR code is also capable of encoding many types of data in addition to the URL itself, including as one non-limiting example data that can be appended to the URL as parameters that enhance the outcome of traversing that URL to the destination.

This data could result from any number of sources or causes, and its transmission could be desirable for many reasons, such as to transmit real-time status information regarding a piece of machinery or a software system, or to transmit a confirmation of the user's identity or access rights, or to transmit information about the user's interactions with the web page on which the QR code is located, or to transmit information about the user's interactions with a digital ad containing the QR code.

This scenario, where the QR code pattern itself is dynamic, rather than merely the URL redirection being dynamic, represents an “ultra-dynamic QR code.” The form of “dynamic QR code” common in existing applications is actually a misnomer because it is the redirection that is dynamic rather than the QR code itself. Such QR codes are completely static on the client side, and only allow for dynamism in the server-side interpretation of an interaction with the QR code. In contrast, this present disclosure describes a QR code that is dynamic per se, changing on the client side in response to local conditions or events in the environment where the code is located. The present disclosure teaches an Ultra-Dynamic QR Code, or “UDQRC”.

A system and method for presenting a digital display incorporating an Ultra-Dynamic QR code are disclosed. The method comprises generating a first set of one or more images comprising a first QR code, encoding data that represents one or more variable values associated with a user interface or an environment in which the QR code is displayed; receiving an input event representing that a change in value has occurred of at least one variable value of the one or more variable values, or that at least one additional value has been added or changed; and generating, as a continued portion of a stream that comprised the first set of one or more images, a second set of one or more images, in which the first QR code is replaced with a second QR code encoding data representing the one or more variable values associated with the digital display, including the change in value of the at least one variable value.

### BRIEF DESCRIPTION OF THE DRAWINGS

Other aspects, features and advantages will become more fully apparent from the following detailed description, the appended claims, and the accompanying drawings (provided solely for purposes of illustration without restricting the scope of any embodiment), of which:

FIG. 1 depicts a sample broadcast user interface incorporating a QR code or other trigger to begin interaction;

FIG. 2 depicts another sample user interface incorporating an ultra-dynamic QR code:

FIG. 3 depicts a back-end system for broadcasting digital content to a human user and for facilitating bidirectional communication;

FIG. 4 depicts a more general computing system for delivering digital content comprising a dynamic QR code to a human user:

FIG. 5 depicts, in simplified form, a method of generating an ultra-dynamic QR code and subsequently updating the QR code in response to an event within or external to a digital interface augmented by the QR code;

FIG. 6 depicts, in simplified form, a method of initiating an interaction from a broadcast;

FIGS. 7A, 7B, 7C, and 7D depict a user interface that updates in response to interaction by the viewer using a secondary device;

FIGS. 8A, 8B, 8C, and 8D depict distinct, sequential moments with the ultra-dynamic QR code from the sample interface illustrated in FIG. 2; and

FIG. 9 depicts a general computing device for performing a number of features described above.

### DETAILED DESCRIPTION

In order to take advantage of new broadcasting media, a family of related applications or use cases are disclosed that depend on the general principle of including instructions to generate a user interface on a device being used to display a broadcast. The instructions take the form of markup language and scripts to generate a webpage-like interface (such as one created in HTML and JavaScript) to be executed by a parser operated by the display device. The display device displays the underlying audiovisual stream while also operating a dynamic user interface that overlays the audiovisual stream and that responds to various user actions or inputs, and/or that directs the user to a particular webpage or application on a secondary device the user operates while watching the broadcast on the primary device.

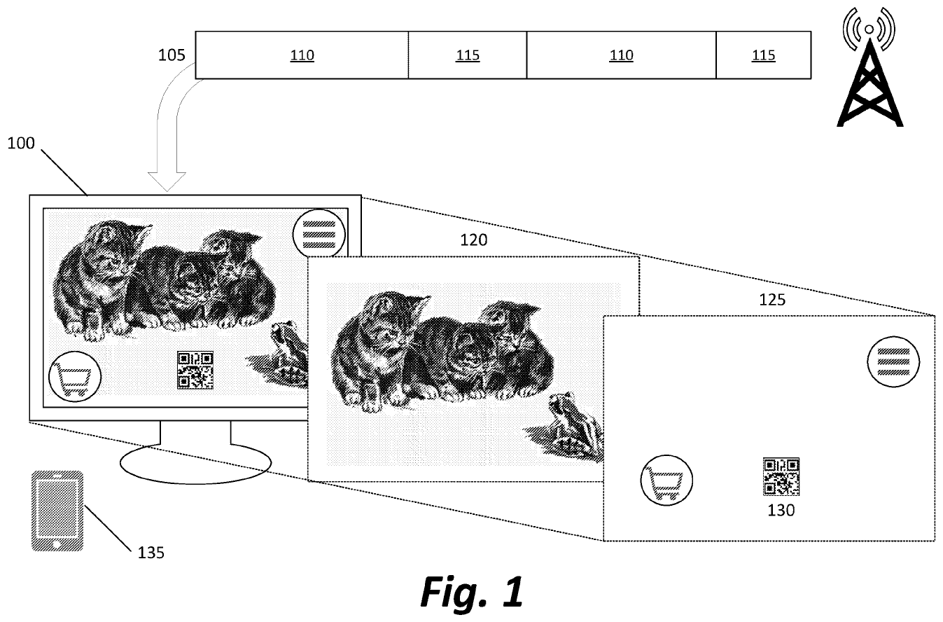

FIG. 1 depicts a sample broadcast user interface incorporating a QR code or other trigger to begin interaction.

When a smart television 100 is used to view an enabled broadcast 105, the stream of packets in that broadcast are divided between the audiovisual-carrying packets 110 and the other IP packets 115, interleaved or multiplexed with the audiovisual-carrying packets.

The audiovisual-carrying packets 110 are used to generate the underlying display 120, while the other IP packets 115 are used to generate an overlaid display 125. In some embodiments, the overlaid display 125 may be generated via instructions interpreted by the applications layer or other features of the ATSC 3.0 specification. In others, the instructions may be embedded in a Secure Interactive Media Interface Definition (SIMID)-compliant transmission that includes code to be executed in conjunction with a video stream. Similar specifications, such as Video Player-Ad Interface Definition (VPAID), Video Ad-Serving Template (VAST), or proprietary software development kits (SDKs) may alternatively be used instead. Regardless of the implementation method chosen, the critical necessity is that an audiovisual stream must be able to be accompanied by software instructions that, when interpreted by software on a TV or other display device, cause that TV or other display device to create portions of a visible or otherwise discernible user interface that was not part of the original audiovisual stream.

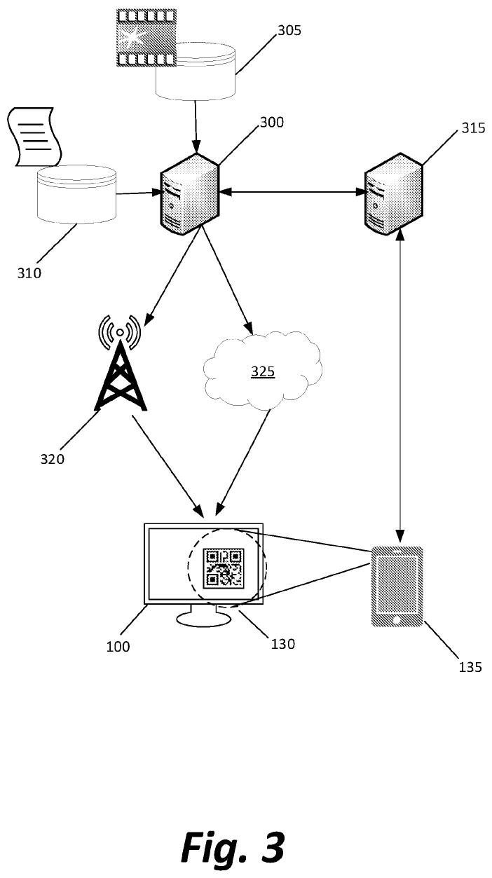

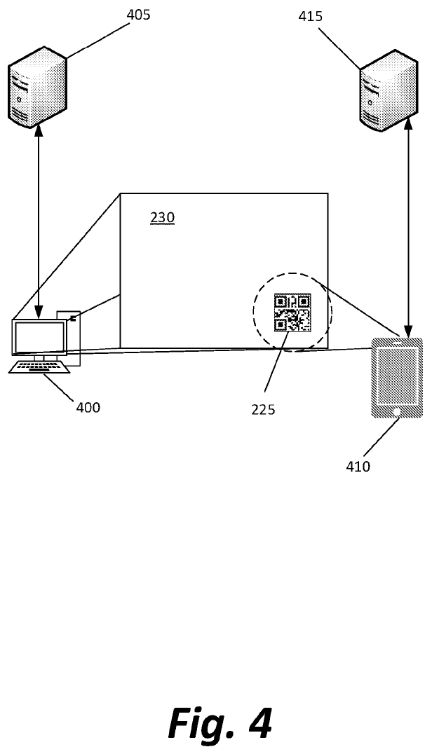

The overlaid display 125 preferably includes a QR code 130 or other similar barcode, graphical encoding, or visual trigger that, when detected by a camera or other sensor of a secondary device 135, permits a viewer operating the secondary device 135 to begin interactions that directly or indirectly affect a user interface of the overlaid display 125. This is preferably accomplished by encoding a URL as the QR code 130 that is visited by the secondary device 135 after the URL is decoded from the QR code. The URL forms part of an API that will take one or more actions when the secondary device 135 makes an HTTP request to the URL, as discussed further below in relation to FIGS. 3 and 4 and following paragraphs.

In a preferred embodiment, the QR code 130 or similar trigger is unique for every instance of the stream being received—that is, if two individuals are receiving the same stream on two different devices at the same moment, the generated QR codes will still be different, and if the same individual is receiving a stream at a later time, the second generated QR code will be different than it was at the first time. Code detailed further below incorporates a unique session ID variable into the QR code's content to accomplish this.

In one alternative embodiment, the QR code 130 or similar trigger is a same code for every viewer of the broadcast, and points the secondary device 135 to a same landing page, after which the viewer is identified by logging in, by source IP address, by cookies present on the secondary device 135, or by any other identifying characteristics of the viewer or the secondary device. In another alternative, the QR code 130 or similar trigger is a same code for every viewer of the broadcast, but the web server or broadcast server have access to a record of which viewers requested a video stream at which times, and can determine a unique possible viewer based on how few viewers were actually watching at the moment of the QR code scan. In another alternative, the QR code 130 is generated such that it uniquely identifies the viewer or the device, but not the video stream. This can be accomplished by code that accesses information stored in the smart television in variables appended to the URL encoded by the QR code. The video stream can then be identified by cross-referencing what video stream had been most recently requested by the given viewer/device. In some embodiments, the QR code is an ultra-dynamic QR code that responds to initial input by changing its encoded URL, according to a process described in further detail in portions of this disclosure below.

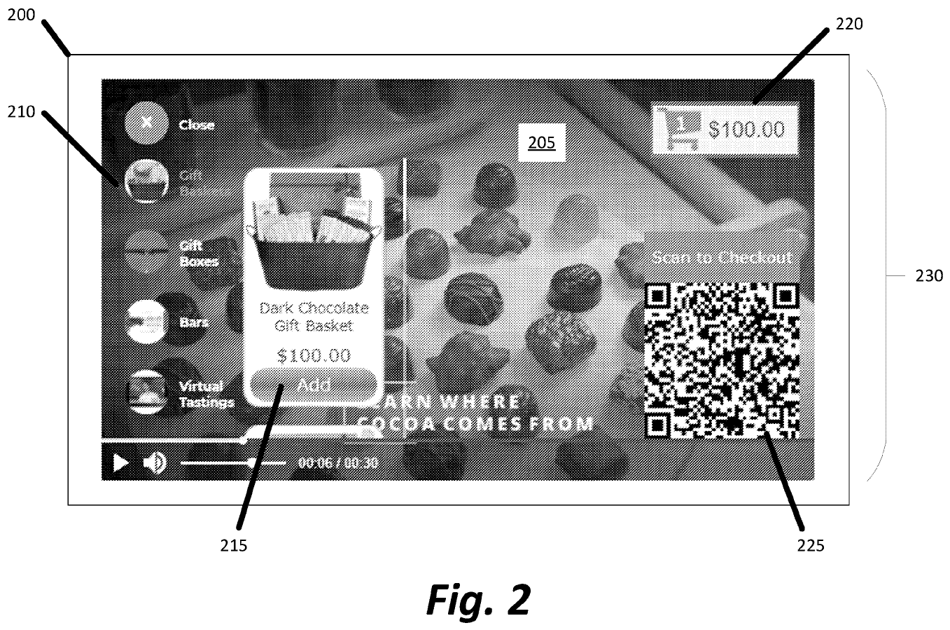

In an example embodiment, the following code initializes a “SESSION_ID” variable associated with an identifiable WebSocket connection between a video and a server 215 (depicted in FIG. 2). It also incorporates the SESSION_ID into a URL, and the URL is used to create the QR code 130 to point the secondary device 135 to a landing page hosted by the server 215 or another server. The server 215 is then able to extract the SESSION_ID from an incoming HTTP request and associate the particular smartphone or other secondary device 135 with the smart television that had displayed the QR code.

```
/**
  * Initialize by creating a WebSocket to the Communicator server.
  */
function initialize( ){
    // Create the WebSocket object we will be connecting to.
    // The SESSION_ID value is created dynamically.
    var socket = new WebSocket(
      ‘wss://communicator.linkstorm.net/’,
      SESSION_ID+“_ad”
    );
    // Open a WebSocket connection to the Communicator server.
    socket.addEventListener(“open”, ( ) =>{
      var msg = ‘{“SessionID”:“‘+SESSION_ID+’”, “SessionType”: “ad”}’;
      socket.send(msg);
    });
    // Handle an incoming message from the Communicator
    socket.onmessage = function(e) {
      // Run custom code on the television that reacts to a message sent
through the Communicator from a landing page.
    };
}
/**
  *
  * Returns the URL a QR Code will redirect to
  *
  * The Session ID of the video is passed to the landing page as a
connection id
  *
  */
function qrCode( ){
    return qr_code_destination_url = DOMAIN + “/cart.html?connection_id=” +
SESSION_ID + “&data=”;
}
```

Although all preferred embodiments describe associating the display with an audiovisual broadcast, it is not strictly necessary that the broadcast contain both audio and visual content. Even if a broadcast were to contain exclusively audio content with a visual component that were only white noise, a static image frame, a completely black frame, or other display devoid of useful information, a visual display 125 could be overlaid the unchanging or information-free visual aspect. Likewise, if a broadcast were to contain exclusively video content and be silent or have white noise or other information-free sound, the functionality of the visual display 125 would be completely unaffected by the lack of sound. In some embodiments, it is even conceivable that instead of using a visual code 130 to connect the secondary device 135 to a broadcast origination server, an audio code might be used instead, such as a series of tones in a subsonic or ultrasonic frequency detectable by a microphone of the secondary device 135 and that do not interfere with a listener's enjoyment of the broadcast.

Although the device 100 is referred to throughout this disclosure as a television, any other device that is compatible with a protocol for mixing broadcast video streams with additional code data may be used instead. This may include a laptop computer, a desktop computer and monitor, a tablet, a gaming console, a handheld gaming device, a display in the dashboard of a vehicle or other display within a vehicle, a smart watch, a personal digital assistant, a monitor at a kiosk, or any other device capable of simultaneously displaying video and also executing software simultaneously. Similarly, although the secondary device 135 is envisioned primarily as a smartphone, in other embodiments, the device may be a smart watch, smart glasses, a camera connected to a smart home system, or any other device with a camera or similar optical scanner capable of picking up a QR code in the frequencies at which the QR code reflects radiation, or having any other form of sensor able to capture data from another form of code 130.

As previously mentioned, although the ATSC 3.0 standard or the SIMID specification is preferred as the protocol via which to transmit the broadcast and the associated code to a smart television, any other method that may come to be common for simultaneously transmitting an audiovisual channel or stream and a data channel or stream to a single device—such that the device could decode both streams simultaneously, interpret one to produce a user interface, and display the other underneath the user interface—might be used instead.

As mentioned above, the QR code 130 in the display may be an ultra-dynamic QR code, and further, ultra-dynamic QR codes may be incorporated into displays other that broadcast video streams. For another example, FIG. 2 depicts a sample user interface incorporating a dynamic QR code.

In a video player or other display 200, an underlying video 205 may have a menu 210 superimposed on top of it to allow user interaction while the video 205 plays. Functionality for this form of augmented video is further described in U.S. patent application Ser. No. 16/953,096, “VIDEO ADVERTISEMENT AUGMENTATION WITH DYNAMIC WEB CONTENT”, now allowed as U.S. Pat. No. 11,430,019.

After a user selects an item 215 from the menu 210, a cart icon 220 may appear, but more importantly, a QR code 225 is generated and displayed within the interface.

In this particular use case, the QR code 225 encodes not only a hyperlink to a merchant's website offering the items displayed in the underlying content 205 for sale, but also text describing the items currently added to the cart by interacting with the menu 210. If a second item 215 is clicked and thereby added to the cart, the QR code 225 changes to reflect the updated cart contents.

As a result, an augmented interface 230 is created that includes an ultra-dynamic QR code 225. At any point during the user's shopping and interaction with the menu 210, capturing a photo of the QR code will cause the device capturing the photo to be able to navigate to the merchant's website on that device and have the items already added in the cart and ready for checkout, as depicted and explained more fully in FIG. 3 and the figures that follow it.

FIG. 3 depicts a back-end system for broadcasting digital content to a human user and for facilitating bidirectional communication.

A broadcast origination server 300 coordinates between an audio/video store 305 and a code data store 310 to determine what should be transmitted to the smart television 100, combining input data from each source into the stream 105. Such a transmission may be accomplished in some embodiments by means of radio signals originating at a transmission tower 320 and ultimately passing to an antenna connected to the television 100, or via a satellite repeater and a satellite dish connected to the television 100. In other embodiments, a physical data network 325, such as the Internet, an ethernet, or a cable television network, may connect the origination server 300 to the smart television 100.

As described above, the user interface at the smart television may contain a QR code or other means of directing the secondary device 135 to a web server 315. In an example embodiment, the web server 315 may run code to receive a query or transmission from a secondary device 135 and associate that query or transmission with the particular video that was being watched at that moment:

```
const WebSocketServer = require(′ws′);
//Communicator Object
const Communicator = function(wsPort){
    /**
      * Mapping of session IDs to ad websocket and landing page websocket
connections
      * allows us to associate a specific video websocket with the
websocket created upon loading the landing page
      */
    const that = this;
    this.connectionMap = new Map( );
    this.wss = new WebSocketServer.Server({port: wsPort});
    /**
      * Upon receiving a new connection request, parse the headers to
verify the session ID and type of connection (ad or landing page)
      */
    that.wss.on(″connection″, function(ws, req){
        console.log(″new client connected″);
        let headers;
        let sessionID;
        let clientType;
        try{
          headers = req.headers[′sec-websocket-protocol′].split(″_″);
          sessionID = headers[0];
          clientType = headers[1];
          if(clientType != ″ad″ && clientType != ″landing″){
            console.log(″invalid connection″);
            ws.close( );
            return;
          }
        }catch(e){
          console.log(″invalid connection″);
          ws.close( );
        }
        that.handleIncomingConnection(ws, sessionID, clientType);
    });
    /**
      * Handles the incoming connection request by checking if the session
ID exists in the map and adding it if not.
      * Calls setupNewClientForDualWS to create necessary event handlers
for messages and close events for the new websocket connection.
      * @param {*} ws
      * @param {*} sessionID
      * @param {*} clientType
      */
    this.handleIncomingConnection = function(ws, sessionID, clientType){
        if(!that.connectionMap.has(sessionID)){
          let dualWS = { };
          that.setupNewClientForDualWS(dualWS, ws, clientType, sessionID);
          that.connectionMap.set(sessionID, dualWS);
        } else {
          let mapWS = that.connectionMap.get(sessionID);
          that.setupNewClientForDualWS(mapWS, ws, clientType, sessionID);
          that.connectionMap.set(sessionID, mapWS);
          if(clientType == ″landing″ && typeof mapWS.adWS != ″undefined″){
            mapWS.adWS.send(″bark″);
          }
        }
    }
    /**
      * Takes in a dualWS object (ad websocket and landing page websockets)
and returns the updated dualWS
      * object after adding the new websocket to the object.
      * @param {*} dualWS
      * @param {*} ws
      * @param {*} clientType
      * @param {*} sessionID
      * @returns
      */
    this.setupNewClientForDualWS = function(dualWS, ws, clientType,
sessionID){
        if(clientType == ″ad″ && typeof dualWS.adWS === ″undefined″){
          that.setupAdClient(sessionID, ws)
          dualWS.adWS = ws;
        }else if(clientType == ″landing″ && typeof dualWS.landingWS ===
″undefined″){
          that.setupLandingClient(sessionID, ws);
          dualWS.landingWS = [ ];
          dualWS.landingWS.push(ws);
        }else if(clientType == ″landing″){
          that.setupLandingClient(sessionID, ws);
          dualWS.landingWS.push(ws);
        }
        return dualWS;
    }
    /**
      * Sets up the event handlers for an advertisement websocket
connections
      * @param {*} sessionID
      * @param {*} newClient
      */
    this.setupAdClient = function(sessionID, newClient){
        newClient.on(″message″, function(data){
          console.log(‘Client has sent us: ${(data)}‘);
        });
        newClient.on(″close″, function( ){
          let dualWS = that.connectionMap.get(sessionID);
          dualWS.adWS = undefined;
          that.connectionMap.set(sessionID, dualWS);
          console.log(″client has disconnected″);
        });
    }
    /**
      * Sets up the event listeners for the landing page websocket
connections.
      * @param {s} sessionID
      * @param {*} newClient
      */
    this.setupLandingClient = function(sessionID, newClient){
        newClient.on(″message″, function(data){
          console.log(‘Client has sent us: ${(data)}‘);
        });
        newClient.on(″close″, function( ){
          let dualWS = that.connectionMap.get(sessionID);
          const index = dualWS.landingWS.indexOf(this);
          if(index > −1){
              dualWS.landingWS.splice(index, 1);
          }
          if(dualWS.landingWS.length == 0)
              dualWS.landingWS = undefined;
          that.connectionMap.set(sessionID, dualWS);
          console.log(″client has disconnected″);
        });
    }
}
/**
  * Start the Communicator Websocket Server.
  */
const server = new Communicator(3333);
console.log(″The WebSocket server is running on port 3333″);
```

Upon receiving a query or transmission from the secondary computing device 135, a web server 315 serves a web page or other application to the secondary computing device 135. In an example embodiment, that web page may contain the following code:

```
<html>
  <head><title>TEST</title></head>
  <body>
    <script type=“text/javascript”>
      // Helper function to create a hash out of any passed in url
variables.
      function QtoH( ){
        try{
          var s = location.href.substring(location.href.indexOf(‘?’)+1);
          s = s.split(‘&’);
          var h = [ ];
          for(var i = 0; i < s.length;i++){
            var p = s[i].split(‘=’);
            h[p[0]] = p[1];
          }
          return h;
        }catch(e){
          console.log(e)
        }
      };
      // Create a hash containing all of the url variables.
      var connection = QtoH( );
      // Create the WebSocket object we will be connecting to.
      // The connection_id hash value is passed into the landing page via
the QR Code url.
      var socket = new WebSocket(
        ‘wss://communicator.linkstorm.net/’,
        connection[‘connection_id’]+“_landing”
      );
      // Open a WebSocket connection to the communicator server.
      socket.addEventListener(“open”, ( ) =>{
        var msg = ‘{“SessionID”:“’ +
connection[‘connection_id’]+“_landing” + ‘“, “SessionType”: “landing”}’;
        socket.send(msg);
      });
      // close the WebSocket connection
      socket.addEventListener(“close”, function( ){
        console.log(“connection closed”);
      });
    </script>
    </body>
  </html>
```

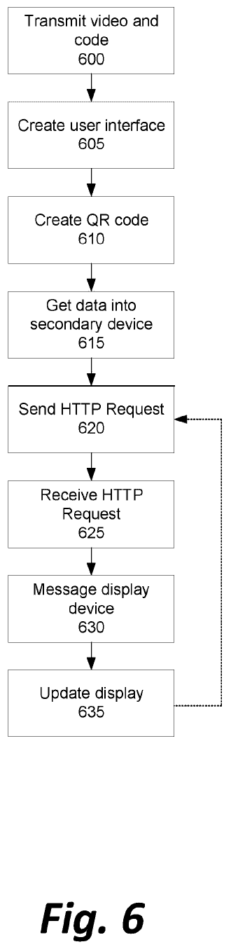

The web server 315 may also communicate with the broadcast origination server 300, instructing the broadcast origination server to communicate further with the smart television 100 to update its user interface, as discussed further below in relation to FIG. 6 and the discussion of the following figures. Additionally or alternatively, code being executed on the smart television 100 may routinely transmit queries to the web server 315 to see if the web server has received a communication from the secondary device 135 that is tied to the current broadcast on the smart television. If the code determines that such an interaction has occurred, conditional logic is executed and aspects of the display may be changed in response-even if the broadcast origination server is unaware that the interaction has occurred, and does not change the underlying stream or metadata associated with it.

Although a preferred configuration of devices is shown in FIG. 3, in some embodiments, any combination of these devices could be on a single device. For example, a single data store could store both the audio/video data for broadcasts and the code for user interface generation (305 and 310). A single server could both generate the broadcast stream and listen for incoming API requests to serve the second user interface (300 and 315). All four of these computing devices or any other subset of them could be combined into a single device if necessary.

Moreover, in some embodiments, rather than a single device performing the function described, a cloud-based solution might provide a functionality through the action of multiple devices in a cluster or distributed geographically. For example, the audio/video data and code might be stored in a content delivery network made up of many access points 305 and 310, such that a server 300 can pull from any access point that is active and available at a given moment. Multiple servers 300 or 315 may operate in load-balancing clusters or different geographic areas to service a number of dispersed users simultaneously.

### Single Device Interactivity

In some embodiments, it may be preferably not to have the viewer hop from a first interface to a second interface on a separate device. In such an instance, it may be possible to use the generated overlay for the broadcast on its own to complete a useful function, without need of an external mobile device such as a mobile phone. For example, after adding items to a cart overlaying an advertisement, the transaction could be completed, and the items purchased, from within the same overlaid interface. It would not be strictly necessary that a QR code or other identifier be used to move the cart onto a new interface or device.

### Multiple Device, Unidirectional Interactivity

In other embodiments, a QR code or other identifier may be used to move to a new interface or device, without necessarily creating a feedback loop that affects the original user interface or underlying broadcast.

FIG. 4 depicts a more general computing system for delivering digital content comprising a dynamic QR code to a human user.

A computing device 400 either contains instructions for generating the augmented interface 230, or otherwise may receive instructions for generating the augmented interface 230 from a web server 405 or other server. The computing device 400 may be, depending on different embodiments, a laptop computer, desktop computer, a smart television, a gaming console, a handheld gaming device, a smart watch, a personal digital assistant, an electronic slot machine or other regulated gaming device, a monitor at a kiosk, self-checkout retail device, or any other device capable of executing software and having a visual output display that can be controlled and updated by software as it executes.

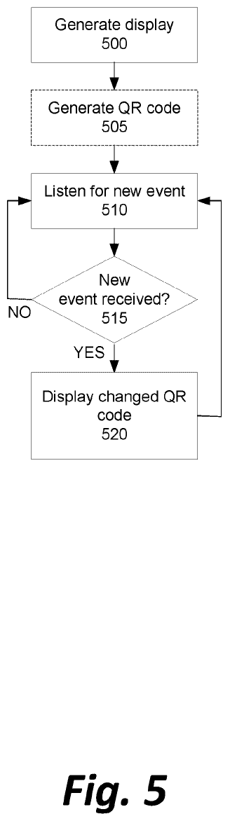

After the computing device 400 begins displaying the augmented interface 230, the QR code 225 of the augmented interface 230 may be repeatedly updated, according to a method described further below in conjunction with FIG. 5.

At any stage during the repeated updating, a second computing device 410 may be used by a viewer or user of the augmented interface 230 to capture an image of the QR code 225. The second computing device 410 is preferably a smartphone in possession of a user of the first computing device 400. In other embodiments, the second computing device 410 may be a smart watch, smart glasses, a camera connected to a smart home system, or any other device with a camera or similar optical scanner capable of picking up a QR code in the frequencies at which the QR code reflects radiation.

The QR code 225 may point to a URL at a different webserver 415, such as a web server for a merchant's website, and the second computing device 410 may be used to continue two-way communication with the different webserver 415 (e.g., to complete and checkout a transaction begun within an advertisement). In other embodiments, the QR code 225 may instead point back to the same server 405 and there may be no need for the servers 405 and 415 to be distinct.

### Ultra-Dynamic QR Code Generation

In order to address the shortcomings of static QR codes, various graphical user interfaces or digital media presentations may be augmented by a QR code that initially encodes a first information content, but is capable of being replaced by a new QR code that encodes a second information content different from the first. This replacement may occur in response to a human user's interaction with the display into which the QR code is embedded, in response to a push communication from a central server that the display is listening for, or any other event detected by a script being executed within the display medium.

FIG. 5 depicts, in simplified form, a method of generating an ultra-dynamic QR code and subsequently updating the QR code in response to an event within or external to a digital interface augmented by the QR code.

Initially, a digital display 230 is generated (Step 500). As previously discussed, the digital display 230 may be a video player with an overlaid interactive menu. In other embodiments, another form of graphical user interface might be used, such as a web page, a dashboard with information or statistics for display, a shopping cart, or a widget on an operating system desktop or mobile phone. Ultimately, any graphical user interface that displays information and/or options to a human user might be used.

In some embodiments, a QR code may already be generated at the first instance of the digital display being displayed (Step 505). In other embodiments, there may not be any QR code visible until a triggering event causes the QR code to be generated and displayed. In such embodiments, the digital display only needs to reserve a region of the display in which the QR code can ultimately be displayed, or to have the ability to rearrange elements of the display to make room for the QR code.

The digital display is configured to listen for one or more types of event (Step 510) that would require a change to the QR code to ensure that the QR code represents a current state of information associated with or represented by the digital display. For example, if the digital display includes a shopping cart, changing the number of instances of an item in the cart will necessitate changing the contents of the QR code to match. For every textual, numerical, or other variable associated with the display (or with an environment that the display contains information regarding) that may change over time, the fact that any such variable has changed may be such an event. If, instead, the QR code is storing a log of a sequence of events, actions, or choices, then each additional such event, action, or choice may trigger an appending of information to that log.

In response to detecting one of the events being listened for (Step 515), the QR code is updated (Step 520) to represent the current state (variables, logs, tokens, etc.) of the display.

Sample code to generate the QR code, and which is re-executed after every triggering event, is included below:

```
/**
  *
  * @param {String} Destination URL of the QR Code
  * @param {Array} Array containing all of the current items in the
shopping cart
  * @param {HTMLElement} HTML Element where the QRCode will draw itself
  */
this.drawDynamicQRCode = function(QRCodeDestionationURL,
ShoppingCartItems, QRCodeParentMenu){
    //the container for the QR code
    var QRcodeHTMLContainer = QRCodeParentMenu.getElementsByClassName(“ls-
qrcode”)[0];
    //set the QRCode container to empty
    QRcodeHTMLContainer.innerHTML = “”;
    //build out the order data string
    var order_data = “”;
    //loop order items and append the product it and the quantity to the url
    //FORMAT: ProductID_QUANTITY|ProductID_QUANTITY|ProductID_QUANTITY|
    for (var i = 0; i < ShoppingCartItems.length; i++){
      if(ShoppingCartItems[i].quantity > 0) {
        //add each product add and the quantity
        order_data += (ShoppingCartItems[i].id + “_” +
ShoppingCartItems[i].quantity + “|”);
      }
    }
    //remove trailing “|” character
    order_data = order_data.substring(0, order_data.length − 1);
    //base64 encode the order_data
    order_data = btoa(order_data);
    //set our new destination URL with order data appended to the end.
    QRCodeDestionationURL = QRCodeDestionationURL + order_data;
    //Fade in the QR code Container after half a second.
    setTimeout(function( ){
      QRCodeParentMenu.style.opacity = “1”;
    }, 500)
    //pass in container and new qrcode destination url and generate code
    //the QRCode will be placed in the HTML container.
    //QR Code is generated using the open source library below.
    //https://github.com/davidshimjs/qrcodejs
    new QRCode(
      QRcodeHTMLContainer, { //Container Housing the QR Code
        text: QRCodeDestionationURL, //url the QRCode will redirect too
        width: 150,
        height: 150,
        colorDark : “#000000”,
        colorLight : “#ffffff”,
        correctLevel : QRCode.CorrectLevel.H
      }
    );
    //return the desitional url for more processing if necessary
    return QRCodeDestionationURL;
}
```

In some embodiments, the change of the QR code may be intended to be highly visible. The entire QR code may disappear from view, and then the new QR code may appear. The change may be supplemented by other elements of the interface or visual effects, including one or more of: a message, a highlighting effect, a flashing effect, use of a color, etc. In other embodiments, the fact that a QR code is changing may be intentionally obscured from the human user's notice. For example, a fade effect or other animation may gradually change the displayed QR code from the original code to the new code so that the human user would not even notice the change unless the human user was looking directly at the QR code during the transition.

After update of the QR code, the display continues listening for subsequent events and updates (back to Step 510), in a continual loop that maintains the relevancy and correctness of the QR code's intended meaning.

In some embodiments, it is possible that the QR code should no longer be displayed once the user has used it to transfer information to a new medium. In these embodiments, the web server at a destination URL encoded by the QR code may transmit a message in response to being accessed by the user's computing device 410. If the display is listening for this communication, it may stop displaying the QR code once the communication is received, thereby cleaning up the user interface if the QR code it incorporates is no longer needed.

Interacting with a Broadcast

FIG. 6 depicts, in simplified form, a method of initiating an interaction from a broadcast as described above.

First, the broadcast origination server 300 begins transmitting video and other IP data to the smart television 100 (Step 600). The IP data includes the instructions to create a user interface that is overlaid on top of the video.

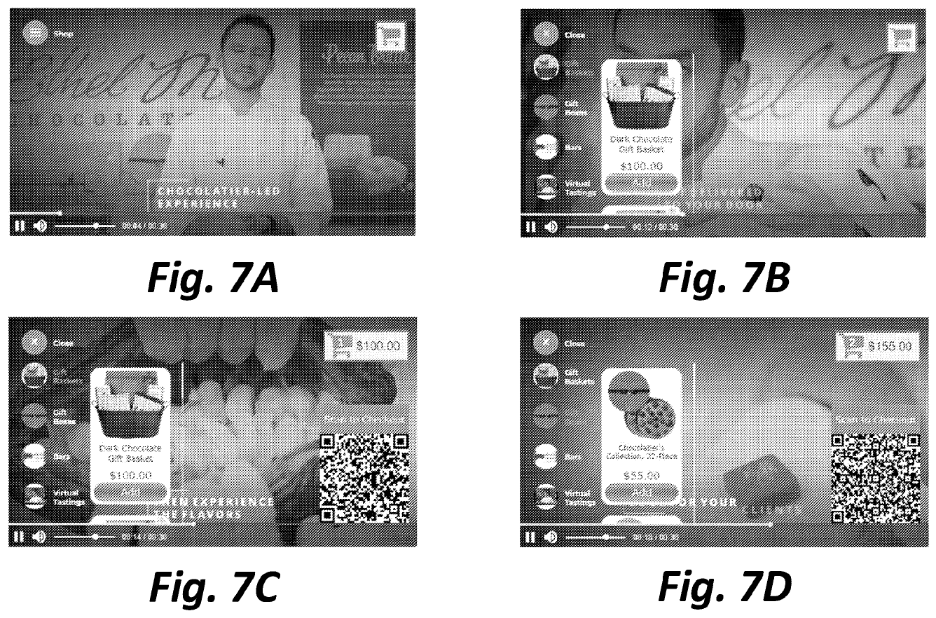

In response to receiving the instructions and executing them, the smart television 100 creates the user interface on top of the video (Step 605). An example generated user interface appropriate for one embodiment of this method is also depicted in its initial state in FIG. 7A, and in subsequent states in FIGS. 7B, 7C, and 7D.

Either immediately, or after an initial interaction with the user interface, a QR code or other identifier, preferably having a URL encoded or embedded within it, may be incorporated into the user interface (Step 610), as is depicted in FIG. 7B. For example, in FIG. 7B, a QR code is only added to the user interface from FIG. 7A if a viewer adds an item to a cart while a video is playing. In other embodiments, the QR code may already be present at the time the user interface is created. In a preferred embodiment, this QR code contains an identifier that is completely unique to a single instance of a viewer using a particular device to view the particular video stream. In other embodiments, the QR code may be unique to a particular device, and not contain information on the video stream being watched, or may be unique to a video stream and not contain information on the device being used. With some greater difficulty, it may be possible to cross-reference this incomplete information with a record of which devices had requested which video streams, and to thereby determine which device is being watched at the time of an interaction using the QR code or other identifier displayed on that device.

The viewer then takes action causing data from the user interface to be made available to the secondary device 135 (Step 615). In a most preferred embodiment, that action is using a mobile device's camera software to extract a URL encoded as or embedded within a QR code. In other embodiments, data might be extracted from another form of bar code, two-dimensional code, bitmap, or pattern visually discernible in the user interface, or via text extraction via optical character recognition applied to the user interface. As previously mentioned, it is also conceivable that a microphone rather than a camera would be used to capture an audio cue instead of a visual cue. This cue could be a subsonic or ultrasonic cue inaudible to a viewer, or might be within an audible range and designed to work with other software on a smartphone or other device listening for audible cues, such as a voice command to Amazon's “Alexa” or Apple's “Siri” Further, instead of automated capture by a camera or microphone, the viewer might be able to enter a URL, passcode, token, or other data string depicted in the user interface via a keyboard, touchscreen, or other input method. If the data string does not contain a URL directly, an application running on the secondary device may be able to convert the data string into an expected URL format.

Using the data from the user interface, the secondary device determines a URL to which to send an HTTP Request, and sends it (Step 620). The URL is hosted by the web server 315, and may be part of an API operated by the web server, such that a request to a given URL constitutes a command or request to be acted upon by the server. If additional optional parameters are appended to the URL, they may constitute additional parameters or arguments associated with the command or request.

The server 315 receives the HTTP request from the secondary device and is thereby notified of the secondary device interaction that is occurring (Step 625). Depending on the purpose of the API operated by the server, the server may parse the URL to determine the command or request and any of its optional parameters, and act in accordance with the API. The server may send no response to the HTTP request, may send a simple acknowledgment such as an HTTP Status 200 “OK” response code, may return a structured response such as a JSON array or other file that contains requested data in response to a query, or may provide a landing page or other web page to be displayed by the secondary device 135. The viewer may optionally continue to interact with the landing page or other web page in parallel to and independent of the subsequent steps. In a preferred embodiment, the server keeps a data structure of every received communication related to QR code scans, including the session ID or other unique identifier included in the QR code. The server also provides an API for a smart television or other device to query the data structure as to whether a QR code currently displayed has been interacted with by the viewer and to receive an affirmative or negative response.

After being notified of the secondary device interaction, the server 315 sends a message to the smart television 100 (Step 630). The message may include merely the fact that the secondary device near the smart television contacted the server, or may include more detailed information such as parameters that have been set or modified during an interaction between the viewer, the secondary device, and the web server. This sending may also take the form either of a “push notification” or a “pull notification” In a push notification embodiment, the broadcasting server may cause further information or code to be incorporated into the metadata accompanying the video stream. In another push notification embodiment, the smart television may be executing code that has a loop checking for incoming messages to a web socket, message queue, or other input processing technique.

Alternatively, in a pull notification embodiment, the smart television may be executing code that has a loop of periodically transmitting a query to an API provided by the web server, for example once every three seconds or a similar or shorter interval of time. When the web server receives the query from the smart television, including the QR code's unique identifier in the query, the web server checks the previously mentioned data structure that tracks whether any other device had actually scanned the same QR code and made a request to the URL encoded as or embedded in the QR code. The web server then transmits a response upon which code on the smart television can act.

The locally executing code on the smart television 100 acts on the received message (Step 635) to update the video or user interface in some way. For example, as depicted in FIG. 7C, the user interface may update to show a message encouraging the viewer to continue interacting with the secondary device 135. The user interface may also update to re-provide the QR code or some other alternative on-ramp to re-continue the interaction if the original secondary device 135 has been mislaid or is no longer useable, but another secondary device can be found and located. Other responses or actions might include changing the underlying video that is playing, displaying additional user interface elements, changing the contents or appearance of existing user interface elements, hiding user interface elements, or any other change needed to accomplish various functionalities described in further detail below.

At any point, the viewer's continued interaction, either with the smart television's user interface via the secondary device or with a landing page or other web page displayed on the secondary device, may cause the secondary device to make an additional transmission to the server (back to Step 620), potentially creating a constant loop of both the smart television's user interface and any user interface rendered on the secondary device being updated in response to viewer choices or inputs. For example, as depicted in FIG. 7D, continued communications between the locally-running software on the smart television and the web server may reveal that a certain expected communication between the secondary device and the web server did or did not occur during a predetermined period of time passing. A subsequent message or content may be displayed to the viewer to reward the viewer for having taken action or to incentivize the viewer to take action not yet taken, as described in more detail below.

### Particular Applications of Broadcast Overlay Technology

As is depicted in FIGS. 7A, 7B, 7C, and 7D, a shopping cart can be overlaid a video about a product (see FIG. 7A). When an item is selected using an input to the smart television, a QR code is displayed (see FIG. 7B) that embeds not only a URL of the merchant who sells that product, but also URL parameters that indicate what item(s) have been added to the shopping cart. Upon scanning the QR code with a smartphone or similar device, the shopping cart is replaced by a message encouraging the viewer to complete the transaction on the merchant's webpage (see FIG. 7C), and/or to re-commence the transaction if it is interrupted in some way before it is completed. The viewer is able to purchase the items on a web page that has been generated and sent to the smartphone. The locally-running software on the television continues to communicate with the web server, and if a predetermined period of time passes (such as a one minute or five minute interval) without the viewer having completed the purchase of the item(s) in the cart, a subsequent message may be displayed to the viewer (see FIG. 7D), reminding the viewer of the incomplete purchase and optionally incentivizing the viewer to complete the purchase by providing a discount, allowing the viewer to skip an advertisement currently being played, providing a small additional product for free in the cart, displaying an encouraging message, or otherwise offering something of objective or subjective value to the viewer.

In another embodiment, a home shopping channel could be used to facilitate online auctions for items displayed on the channel. Upon scanning a QR code or other visual trigger displayed in association with a product on the television screen, the viewer will be able to access an online auction and bid using a smartphone. The on-television display may display any number of alerts or data as the viewer watches, such as the current bidding price, the highest bid previously submitted by the viewer, whether the viewer is the current high bidder, an alert that the viewer has lost high bidder status, the identity/username(s) of other bidders, a timer counting down to the end of the auction, a link to a webpage for the auction for viewing in the television's browser or another device's browser, or any other useful information related to the auction. As a result, the viewer is able to continue participating in the auction without having to continually divide attention between the television and smartphone, and need only return to using his or her smartphone if the television alerts that high bidder status has been lost or another relevant change is communicated.

In another embodiment, real-time, collective polling of viewers could be performed via the secondary devices and displayed on the smart television. For example, a question could be posed to all viewers along with a QR or other visual trigger code that takes the secondary device to a URL that allows selection of a response to the poll. Upon receipt of a viewer's choice by the web server, the television display is also updated to show not only the running totals of other viewers' responses, but the individual viewer's recorded choice, so that the viewer knows his or her vote has been received. This system permits not only interactive opinion or political polling of the type traditionally performed by pollsters, but also interaction with reality television shows or game shows. Viewers can vote for or against competitors or competitors' submission in real time (as is common by telephone poll only in such television shows as Big Brother, Eurovision, The Sing-Off, The Masked Singer, Project Runway, Top Chef, etc.). Viewers can also provide real time feedback during an ongoing performance or interaction, such as positive or negative responses to individual statements of a political debate, or provide a critical mass to veto a performance in progress (similar to how a . . . Got Talent performance is terminated if all four judges vote to dismiss a contestant). In each instance, the current feedback that a viewer is providing is displayed to the viewer, along with optional other information, such as the overall vote tallies or additional information about the option the viewer has selected.

In another embodiment, real-time data regarding either personal or group collective efforts might be displayed on the television screen. For example, during a fundraiser, a QR code or other code might be displayed along with an encouragement to donate to a particular charity, non-profit, public radio or television station, etc. Upon using the smartphone or other secondary device to pledge or actually transfer funds to a recipient, the television screen would display not only the collective amount of funds pledged or donated and a progress bar or “thermometer” with progress towards a goal, but also the viewer's individual contribution. If there are other rewards associated with donation, such as access to an ad-free content stream, access to a content stream that omits requests for additional donations, or access to coupon codes provided by a charity's partners, any of all of that data would also be provided immediately via the interface on the television.

In another embodiment similar to the two previous embodiments, collective action could be encouraged by showing content, coupon codes, or other material if and only if a certain threshold of all users' participation is met. For example, if a television program is showing a product that may or may not be commercialized in the future (such as one shown on “Shark Tank” or a similar entrepreneurial program), viewers may be encouraged to use a QR code or other code to go to an online page and preorder the product. If a sufficient critical mass of pre-orders is reached, the viewers may be rewarded by a guarantee that the product will be produced and the pre-orders filled, a guarantee that an investor on the program will partner with the product's owner, or even a guarantee of a discount on the price compared to the price to be paid by non-supporters when the product is produced. A discount might be provided exclusively on the backend by associating a particular viewer with a preorder commitment, or provided additionally or alternatively by providing a coupon code or other information that makes the discount possible in the future.

In another embodiment, an interactive game may be displayed on top of an underlying video content. The interactive game may be exclusively local (such as two players in a same room watching the television) or remote (allowing one player watching the television to play against an opponent in an arbitrary, different location). After linking a smartphone by scanning a QR code or other visual trigger in the game interface, the viewer is able to input a move or selection and see a result of that move or selection on the television, along with the underlying video content. Moreover, even in a game that is primarily played on a smartphone, the television may alert the viewer visually that it is their turn or another development in the game has occurred. As a result, the viewer need not look at the smartphone to see if the game state has advanced, and need not turn his or her attention away from the video content unnecessarily. The television may display a split screen of the underlying video content and the current game state, especially if the game is a real-time game instead of a turn-based game.

In another embodiment, scanning a QR code or other visual trigger may cause the television to be linked to a social networking site with which the viewer has an account. The viewer may then be able to see in real time new posts, comments, content, upvotes, likes, shares, retweets, reactions, subscriptions, or other information associated with others' use of the social network while the viewer is watching the underlying video content.

In another embodiment, scanning a QR code or other visual trigger may link a smartphone to the television and permit the smartphone to act as a remote control, providing input on the smartphone that is conveyed to the backend servers and down to the television, to allow the channels, volume, or other settings associated with the television to be changed. These functionalities can be enabled even if the smartphone has no direct means of communicating with the television (they are on different networks, the television lacks a Bluetooth receiver, the smartphone lacks an infrared transmitter, etc.), vastly increasing the convenience of controlling a television when a remote control has been lost, damaged, or lacks batteries.

In another embodiment, scanning a QR code or other visual trigger may allow the viewer to save or transfer a video stream that the viewer is unable to continue watching on the television. For example, if the viewer needs to leave the room or leave their residence entirely, scanning the QR code may cause the same video stream to begin playing on the smartphone used to scan the QR code, may cause a link to a cached video stream to be emailed to the viewer for viewing later, may cause the timestamp of the video stream to be saved so that the viewer can begin the video stream from the same moment during a future viewing, may cause the video stream to be delayed or paused until the viewer returns, or any other similar interaction.

In another embodiment, scanning a QR code or other visual trigger may cause a message queue or other source of content available to the smartphone and associated with the viewer to be linked to the television as well. Calendar items, to-do tasks, unread text messages, unread emails, voicemails, or other messages or reminders may continue to be displayed to the viewer along with the underlying video content. Moreover, one or more mobile applications being executed by the smartphone may have their notifications linked to the television, such that the viewer need not look at his or her smartphone to see notifications, but will instead see them overlaying or alongside the content stream from the television. A QR code in an advertisement for a mobile app may be used to simultaneously trigger an installation of the app on the smartphone that scans it, and to link the smartphone and app to the television that displayed the QR code, enabling further interactivity. In-app notifications may affect behavior of an overlaid display on the television, and/or use of a smartphone to interact with an overlaid display on the television may affect behavior of the app even if the app is not open on the smartphone at the time of the interaction.

In another embodiment, an ancillary video stream—such as a public service/safety announcement, emergency weather warning, other announcement, message from a program's sponsors, or advertisement—may be displayed to a viewer along with a QR code or other visual trigger for a website associated with it. If the viewer is willing to visit the website by scanning the QR code or other visual trigger with a smartphone, the ancillary video stream will be short-circuited; the viewer is returned to the intended content that was playing before the ancillary video interrupted the intended content, before the full length of the ancillary video stream has been played. Users may also be able to “earn” an interval of advertisement-free viewing time by confirming that they are using the smartphone or another secondary device to play ads in parallel with an ad-free television stream, by completing a poll or purchase associated with a product in an advertisement, by sharing some ad-related content on social media or via interpersonal communications using the smartphone, and so on.

### Dynamic QR Code Example

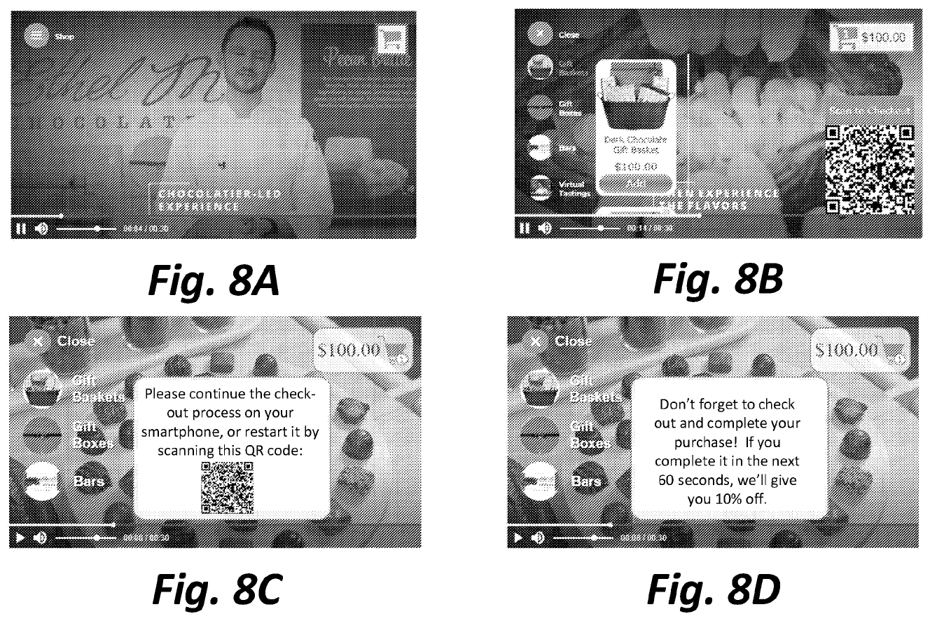

FIGS. 8A, 8B, 8C, and 8D depict distinct, sequential moments from the embodiment illustrated in FIG. 2.

Initially, as depicted in FIG. 8A, a video is displayed with an overlaid icon for a shopping menu in the top left corner and an icon for a shopping cart in the top right corner.

Upon mousing over or clicking the menu icon, a cascading, multi-level menu is displayed with various items that can be added to a cart, as shown in FIG. 8B.

When the viewer clicks “Add” to add an item to the cart, the cart icon is updated (now showing one item worth $100.00) and a QR code is generated in the bottom right corner, as shown in FIG. 8C. If the QR code were to be scanned at this stage by a smartphone or other computing device, the smartphone would navigate to a cart checkout page on the merchant's website and would have automatically added the item to the cart there by means of a token included in the URL encoded by the QR code.

If the viewer clicks “Add” on a second item, the cart icon is updated again (now showing two items collectively worth $155.00), and the QR code is updated and no longer includes the same token information that was present before. If the QR code were to be scanned at this stage by the smartphone or other computing device, the smartphone would navigate to the cart checkout page on the merchant's website and would have automatically added both items to the cart.

### Additional Dynamic QR Code Embodiments

As is depicted in FIGS. 2, 8C, and 8D, dynamic QR codes enable a shopping cart to be incorporated into a webpage without a user login or even the use of cookies. All of the information regarding contents of the cart can be encoded in the URL itself, rather than being saved in a cookie or associated with a user's login.

In a video player or website that serves videos (such as YouTube, TikTok, etc.) a QR code might be displayed in association with the video, and that contains information regarding the current timestamp of the video. If the viewer of the video needs to pause the video and walk away from the computer, the viewer could use a smartphone to scan the QR code and open the same video on the smartphone, already advanced to the same timestamp, without requiring the viewer to be logged into the website presenting the video, and without any other tracking apparatus.

A digital advertisement that will be displayed on a website or a mobile device or a television set or a VR environment may be augmented with a QR code that contains a hyperlink to a particular page on the advertiser's website. After the website and advertisement have been loaded, a script on the hosting website may contact the advertiser's website with information on the user, such as identification, demographic information, detected cookies, or other data. The advertiser's website may respond by providing a different, more targeted hyperlink that should be encoded by the QR code. If the user then scans the QR code and goes to the advertiser's website on their smartphone, the user is then shown a page different from the page to which the generic version of the ad would lead, and/or can be tracked by incorporation of a token in the URL that the QR code encodes.

A digital advertisement may include a QR code that is automatically updated to include data documenting the user's interactions with the advertisement up to that point, such as which elements of the ad they had interacted with, for how long, in what order, etc.

An automated concierge display or kiosk display might be configured to receive a series of choices of locations to which a user wishes to travel, and generate a QR code that includes locations/directions. Upon scanning the QR code, a map app on the user's smartphone could automatically load the list of locations and directions to aid the user in navigating to those locations.

A smartwatch, smartphone, or other portable display that also comprises sensors could be used as a form of medical “black box” to be accessed by paramedics or other personnel encountering an unconscious person. The QR code displayed on a screen of the smartwatch or smartphone could include information such as the pulse rate of the individual over the past hour, the last time the individual ate, the last time the individual was conscious, or other information that could be used to differentially diagnose an individual who is not conscious or otherwise able to provide a medical history. A paramedic scanning the QR code could instantly access the history and provide better care to a patient as a result. For example, an unconscious person who had suffered a heart attack might be indicated by a rapid and irregular pulse prior to an abrupt loss of consciousness detected by a wearable device's accelerometer, while an unconscious person who is suffering a diabetic coma might be indicated by a number of hours passed since the last meal, or even by low blood sugar indicated by a smart medical device constantly monitoring the individual's blood sugar level. All of these variables can be constantly displayed, in an obscured way, by a dynamic QR code displayed on a smartwatch or smartphone. Similar “black box” functionality could be incorporated into devices, such as a car that has been in a crash, an appliance that has ceased functioning, or even an appliance that is still functioning but that has status information or error messages to display to the appliance's user.

A computer, printer, piece of machinery, or any other type of device or appliance could display a QR code that would incorporate real-time information about the operational status of the device, such as the existence of any component failures, causes for slowness, error codes, other diagnostic information, refueling or recharging requirements, power utilization, temperature information, etc. Upon scanning the QR code with a smartphone or other device, the smartphone would be able to respond by displaying specific instructions to a repair person or maintenance worker, or to request a software update or patch, or to order a replacement part, etc.

A QR code could represent a digital ID, a digital signature, an encoding of access rights or permissions, or any other object for purposes of validating the identity of an individual person or a device or a document, with or without being accompanied by data that further informs as to the conditions or circumstances of the object's encoding, such as a timestamp accompanying a signature, a blockchain history, a snapshot of current device conditions, or any other information supporting identification, validation or current conditions. As any element of the recorded information changes or is added to, the QR code is similarly updated to reflect the changed information.

QR codes could also be used to augment a physical cart, tray, or other container used while selecting items at a physical retail storefront, cafeteria, or other establishment. For example, a cart might contain an RFID chip reader that detects a chip on each item as it is placed into the cart. As each item is collected, a QR code on a display associated with the cart updates to include information on the contents and on the total cost of the contents. When the cart is brought to a cashier for checkout, the cashier need only scan the QR code, rather than individually handle and scan each item. This would result in much faster and less-error-prone handling of the checkout process, and better customer experiences.

At a casino, an electronic gaming machine such as a slot machine or video poker might display a QR code when a player earns a payout, and then continually update the QR code if the player continues to play using the funds of the payout. For example, if the player initially wins $1000 on a hand of poker, the QR code would initially represent this fact, but if the player used these winnings to pay a $20 ante on the next hand, the QR code would be updated to represent that the player's winnings are now only $980 If the player won the next hand with a pot of $1000 as well, the QR code might be updated yet again to $1980. At any point when the player wishes to cease play, he or she could use a smartphone to capture the QR code, then have the winnings automatically deposited in an account of the player's choosing, or take the smartphone to a cashout window and demonstrate (via the QR code and a security token included along with the balance) that the player is entitled to the winnings. As a result, the player never has to carry around or manipulate chips with a risk of loss or theft.

### Computing Technology in General

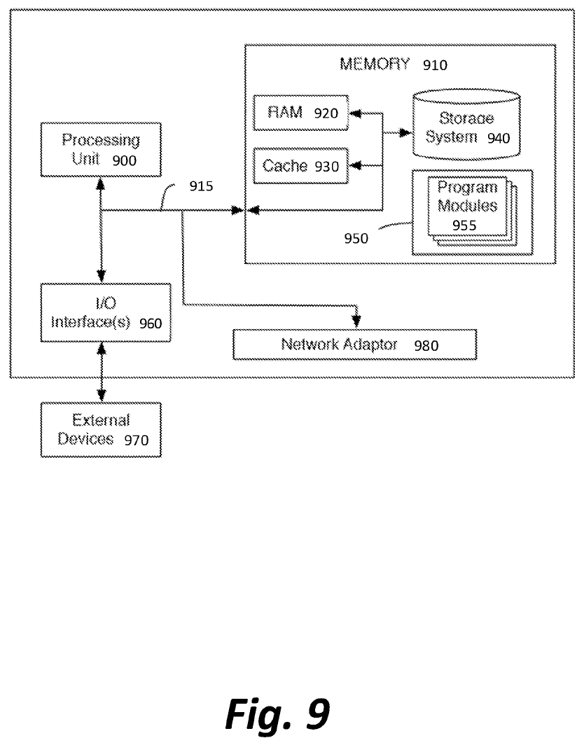

FIG. 9 is a high-level block diagram of a representative computing device that may be utilized to implement various features and processes described herein, for example, the functionality of the secondary computing device 135, broadcast origination server 300, data stores 305 and 310, web server 315, computing device 400, webserver or other interface source device 405, scanning computing device 410, or other webserver 415. The computing device may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 9, the computing device is illustrated in the form of a special purpose computer system. The components of the computing device may include (but are not limited to) one or more processors or processing units 900, a system memory 910, and a bus 915 that couples various system components including memory 910 to processor 900.

Bus 915 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Processing unit(s) 900 may execute computer programs stored in memory 910. Any suitable programming language can be used to implement the routines of particular embodiments including C, C++, Java, assembly language, etc. Different programming techniques can be employed such as procedural or object oriented. The routines can execute on a single computing device or multiple computing devices. Further, multiple processors 900 may be used.

The computing device typically includes a variety of computer system readable media. Such media may be any available media that is accessible by the computing device, and it includes both volatile and non-volatile media, removable and non-removable media.

System memory 910 can include computer system readable media in the form of volatile memory, such as random access memory (RAM) 920 and/or cache memory 930. The computing device may further include other removable/non-removable, volatile/non-volatile computer system storage media. By way of example only, storage system 940 can be provided for reading from and writing to a non-removable, non-volatile magnetic media (not shown and typically referred to as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 915 by one or more data media interfaces. As will be further depicted and described below, memory 910 may include at least one program product having a set (e.g., at least one) of program modules that are configured to carry out the functions of embodiments described in this disclosure.

Program/utility 950, having a set (at least one) of program modules 955, may be stored in memory 910 by way of example, and not limitation, as well as an operating system, one or more application software, other program modules, and program data. Each of the operating system, one or more application programs, other program modules, and program data or some combination thereof, may include an implementation of a networking environment.

The computing device may also communicate with one or more external devices 970 such as a keyboard, a pointing device, a display, etc.; one or more devices that enable a user to interact with the computing device; and/or any devices (e.g., network card, modem, etc.) that enable the computing device to communicate with one or more other computing devices. Such communication can occur via Input/Output (I/O) interface(s) 960.

In addition, as described above, the computing device can communicate with one or more networks, such as a local area network (LAN), a general wide area network (WAN) and/or a public network (e.g., the Internet) via network adaptor 980. As depicted, network adaptor 980 communicates with other components of the computing device via bus 915. It should be understood that although not shown, other hardware and/or software components could be used in conjunction with the computing device. Examples include (but are not limited to) microcode, device drivers, redundant processing units, external disk drive arrays, RAID systems, tape drives, and data archival storage systems, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed:

1. A system for creating a bidirectional user interface associated with an audiovisual broadcast, comprising:
one or more servers transmitting the audiovisual broadcast to a display device;
one or more processors among the one or more servers and the display device; and
non-transitory memory storing instructions that, when executed by the one or more processors, cause the one or more processors to:
transmit, along with the audiovisual broadcast, instructions to generate a first user interface that is overlaid over the audiovisual broadcast by a device displaying the audiovisual broadcast;
receive a first command from a viewer of the audiovisual broadcast, causing an update to one or more values associated with the first user interface;
create, within the generated user interface overlay, an identifier to be used to access a second user interface on a second device; capture the identifier with the second device; generate the second user interface on the second device;
receive a second command from the viewer as the viewer uses the second device;
update the one or more values again; and
update the first user interface to display information related to the updated one or more values that were updated from within the second user interface.

2. The system of claim 1, wherein the second device is a mobile computing device and the identifier is captured via a camera of the mobile computing device.

3. The system of claim 1, wherein the identifier is encoded as a Quick Response (QR) code.

4. The system of claim 3, wherein the Quick Response (QR) code is dynamic and changes after its initial creation in response to commands after the first command from the viewer of the audiovisual broadcast.

5. The system of claim 1, wherein the instructions, when executed by the one or more processors, further cause the one or more processors to:
determine that an expected command has not been received within the second user interface; and
update the first user interface to display a prompt to resume interaction with the second user interface or a new user interface on a new device distinct from the second device.

6. The system of claim 1, wherein the instructions, when executed by the one or more processors, further cause the one or more processors to:
determine, via the capture of the identifier with the second device, that the viewer operating the second device is watching the audiovisual broadcast; and
in response to the determination, cause a change in future output of the audiovisual broadcast.

7. The system of claim 1, wherein the instructions, when executed by the one or more processors, further cause the one or more processors to:
use the generated user interface overlay as a shopping cart;
track insertion of items into the shopping cart upon receiving user selections of items in the generated user interface overlay; and
complete a transaction for the shopping cart within the generated user interface overlay.

8. The system of claim 1, wherein the instructions, when executed by the one or more processors, further cause the one or more processors to:
display a video announcement or advertisement incidental to the audiovisual broadcast and intended to be seen by the viewer operating the second device;
determine, via the capture of the identifier with the second device, that the viewer operating the second device is now viewing information associated with the video announcement or advertisement using the second device; and
in response to the determination, cease display of the video announcement or advertisement and return to displaying the audiovisual broadcast.

9. A method for creating a bidirectional user interface associated with an audiovisual broadcast, comprising:
transmitting, along with the audiovisual broadcast, instructions to generate a first user interface that is overlaid over the audiovisual broadcast by a device displaying the audiovisual broadcast;
receiving a first command from a viewer of the audiovisual broadcast, causing an update to one or more values associated with the first user interface;
creating, within the generated user interface overlay, an identifier to be used to access a second user interface on a second device;
capturing the identifier with the second device; generating the second user interface on the second device;
receiving a second command from the viewer as the viewer uses the second device;
updating the one or more values again; and
updating the first user interface to display information related to the updated one or more values that were updated from within the second user interface.

10. The method of claim 9, wherein the second device is a mobile computing device and the identifier is captured via a camera of the mobile computing device.

11. The method of claim 9, wherein the identifier is encoded as a Quick Response (QR) code.

12. The method of claim 11, wherein the Quick Response (QR) code is dynamic and changes after its initial creation in response to commands after the first command from the viewer of the audiovisual broadcast.

13. The method of claim 9, further comprising:
determining that an expected command has not been received within the second user interface; and
updating the first user interface to display a prompt to resume interaction with the second user interface or a new user interface on a new device distinct from the second device.

14. The method of claim 9, further comprising:
determining, via the capture of the identifier with the second device, that the viewer operating the second device is watching the audiovisual broadcast; and
in response to the determination, causing a change in future output of the audiovisual broadcast.

15. The method of claim 9, further comprising:
using the generated user interface overlay as a shopping cart;
tracking insertion of items into the shopping cart upon receiving user selections of items in the generated user interface overlay; and
completing a transaction for the shopping cart within the generated user interface overlay.

16. The method of claim 9, further comprising:
displaying a video announcement or advertisement incidental to the audiovisual broadcast and intended to be seen by the viewer operating the second device;
determining, via the capture of the identifier with the second device, that the viewer operating the second device is now viewing information associated with the video announcement or advertisement using the second device; and
in response to the determination, ceasing display of the video announcement or advertisement and returning to displaying the audiovisual broadcast.
